(19) United States
(12) Patent Application Publication
(10) Pub. No.: US 2011/0019602 A1
(43) Pub. Date: Jan. 27, 2011

(54) APPARATUS AND METHOD FOR OPERATING SLEEP MODE

(75) Inventors: Giwon Park, Gyeonggi-Do (KR); Yongho Kim, Gyeonggi-Do (KR); Kiseon Ryu, Gyeonggi-Do (KR)

Correspondence Address: LEE, HONG, DEGERMAN, KANG & WAIMEY, 660 S. FIGUEROA STREET, Suite 2300, LOS ANGELES, CA, 90017, US

(73) Assignee: LG Electronics Inc.

(21) Appl. No.: 12/824,085

(22) Filed: Jun. 25, 2010

Related U.S. Application Data
(60) Provisional application No. 61/220,586, filed on Jun. 26, 2009.
(60) Provisional application No. 61/222,907, filed on Jul. 2, 2009.
(60) Provisional application No. 61/223,681, filed on Jul. 7, 2009.
(60) Provisional application No. 61/241,032, filed on Sep. 10, 2009.
(60) Provisional application No. 61/244,836, filed on Sep. 22, 2009.

(30) Foreign Application Priority Data
Nov. 9, 2009 (KR) 10-2009-0107726

(51) Int. Cl. H04W 52/02

(52) U.S. Cl. 370/311

(57) ABSTRACT

Disclosed herein relates to a sleep mode operation method, and more particularly, to a method for operating a sleep mode in a mobile communication terminal, including transmitting a sleep mode request message including a sleep cycle information for entering into the sleep mode to a base station; receiving a sleep mode response message including a sleep mode operating parameter from the base station; changing the state to the sleep mode referring to the sleep mode operating parameter; receiving a traffic indication message including a positive traffic indicator from the base station; and adjusting to a current sleep cycle according to the sleep cycle information included in the sleep mode request message; wherein the sleep cycle information is an information indicating to extend a current sleep cycle to the small value of twice the previous sleep cycle and a final sleep cycle or to reset the current sleep cycle to an initial sleep cycle or a new initialized sleep cycle.

### RELATED APPLICATION

Pursuant to 35 U.S.C. §119(a)-(e), this application claims the benefit of U.S. Provisional Application No. 61/220,586, filed on Jun. 26, 2009, U.S. Provisional Application No. 61/222,907, filed on Jul. 2, 2009, U.S. Provisional Application No. 61/223,681, filed on Jul. 7, 2009 and Korean Patent Application No. 10-2009-0107726, filed on Nov. 9, 2009, the contents of which are incorporated by reference herein in their entireties.

### BACKGROUND OF THE INVENTION

1. Field of the Invention

The present invention relates to a sleep mode operation apparatus and method, and more particularly, to an apparatus and method for operating a sleep mode capable of adjusting a sleep cycle according to the data traffic characteristic.

2. Description of the Related Art

The problem of power consumption in terminals may be a considerably important element in a broadband wireless mobile communication system compared to other systems because the mobility of terminals should be considered. A sleep mode operation between a terminal and a base station has been proposed as one of such methods for minimizing power consumption in the terminal.

In a conventional sleep mode operation, a terminal requests to enter into a sleep mode if there exists no more traffic to be transmitted and/or received to and/or from a base station while performing a communication with the base station in an active mode, and receives a response to that request from the base station to change the state thereof to a sleep mode.

The terminal that has entered into a sleep state receives a message indicating whether there exists a traffic transferred from the base station during a sleep listening window, and determines that there exists no data traffic transmitted to a downlink, and increases the current sleep cycle twice if negative indication indicating that there exists no traffic is received.

Furthermore, if positive indication is received from the base station during the listening window, then the terminal determines that there exists data traffic transferred to a downlink, and initializes the current sleep cycle. At this time, the type of data traffic that can be received by a terminal may be a real time or non-real time service, and it has a feature that packet data transmitted and/or received to and/or from the terminal will have non-periodicity if a non-real time service is received such as short message, and packet data transmitted and/or received to and/or from the terminal will have periodicity if a real time service is received such as VoIP (Voice on IP).

However, according to the related art, if positive indication is received from the base station in the listening window, then the sleep cycle is initialized because the terminal indiscriminately initializes the sleep cycle without distinguishing the type of data traffic received by the terminal even in a case of receiving non-real time services having a non-periodic characteristic, similarly to a case of receiving real time services, thereby causing unnecessary power consumption.

As a result, the operation of sleep mode is not distinguished according to the services received by the terminal, thereby causing a problem that power reduction is not so effective in a terminal.

### SUMMARY OF THE INVENTION

An object of the present invention is to provide a sleep mode operation method and apparatus capable of adjusting a sleep cycle according to the type of data traffic received by a terminal in the sleep mode operation.

In order to accomplish the foregoing object, a sleep mode operation method according to an embodiment of the present invention, in a method for operating a sleep mode in a mobile communication terminal, is characterized by including transmitting a sleep mode request message including a sleep cycle information for entering into the sleep mode to a base station; receiving a sleep mode response message including a sleep mode operating parameter from the base station; changing the state to the sleep mode referring to the sleep mode operating parameter; receiving a traffic indication message including a positive traffic indicator from the base station; and adjusting to a current sleep cycle according to the sleep cycle information included in the sleep mode request message, wherein the sleep cycle information is an information indicating to extend a current sleep cycle to the small value of twice the previous sleep cycle and a final sleep cycle or to reset the current sleep cycle to an initial sleep cycle or a new initialized sleep cycle.

In order to accomplish the foregoing object, a sleep mode operation method according to another embodiment of the present invention, in a method for operating a sleep mode in a mobile communication terminal, is characterized by receiving a traffic indication message including a positive traffic indicator from the base station; receiving a control information message including a sleep cycle information during a listening window of the sleep mode from the base station; and adjusting to a current sleep cycle considering the sleep cycle information included in the control information message, wherein the sleep cycle information is an information indicating to extend a current sleep cycle to the small value of twice the previous sleep cycle and a final sleep cycle or to reset the current sleep cycle to an initial sleep cycle or a new initialized sleep cycle.

In order to accomplish the foregoing object, a sleep mode operation apparatus according to an embodiment of the present invention is characterized by including a transmitter to transmit a sleep request message to a base station; a receiver to receive a sleep response message including a sleep operating parameter and a data traffic indication message from the base station; and a controller to adjust a current sleep cycle considering a sleep cycle information, wherein the sleep cycle information is an information indicating to extend a current sleep cycle to the small value of twice the previous sleep cycle and a final sleep cycle or to reset the current sleep cycle to an initial sleep cycle or a new initialized sleep cycle.

According to the present invention, in a sleep mode operation of the terminal, the operation of sleep mode is distinguished according to the services received by the terminal, thereby having the effect of maximizing power reduction in the terminal.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a configuration diagram sequentially illustrating a sleep mode operation according to an embodiment of the present invention;

FIG. 2 is a view illustrating a typical sleep mode operation;

FIG. 3 is a view illustrating that the sleep cycle is reset to an initial sleep cycle in case where SCF is set to “0” and transferred to a terminal;

FIG. 4 is a view illustrating that the sleep cycle is increased to twice the previous sleep cycle in case where SCF is set to “1” and transferred to a terminal; and

FIG. 5 is a block diagram schematically illustrating a sleep mode operation apparatus according to an embodiment of the present invention.

### DETAILED DESCRIPTION OF THE INVENTION

Hereinafter, preferred embodiments of the present invention will be described in detail with reference to the accompanying drawings, and the same or similar elements are designated with the same numeral references regardless of the numerals in the drawings and their redundant description will be omitted. In describing the present invention, moreover, the detailed description will be omitted when a specific description for publicly known technologies to which the invention pertains is judged to obscure the gist of the present invention. Also, it should be noted that the accompanying drawings are merely illustrated to easily explain the spirit of the invention, and therefore, they should not be construed to limit the spirit of the invention by the accompanying drawings.

Hereinafter, the term “device” herein is used with a meaning, commonly referred to as a user equipment (UE), a mobile equipment (ME), and a mobile station (MS). Furthermore, the device may be portable equipment such as a portable phone, a PDA, a smart phone, and a notebook, or non-portable equipment such as a PC, and a vehicle-loaded device.

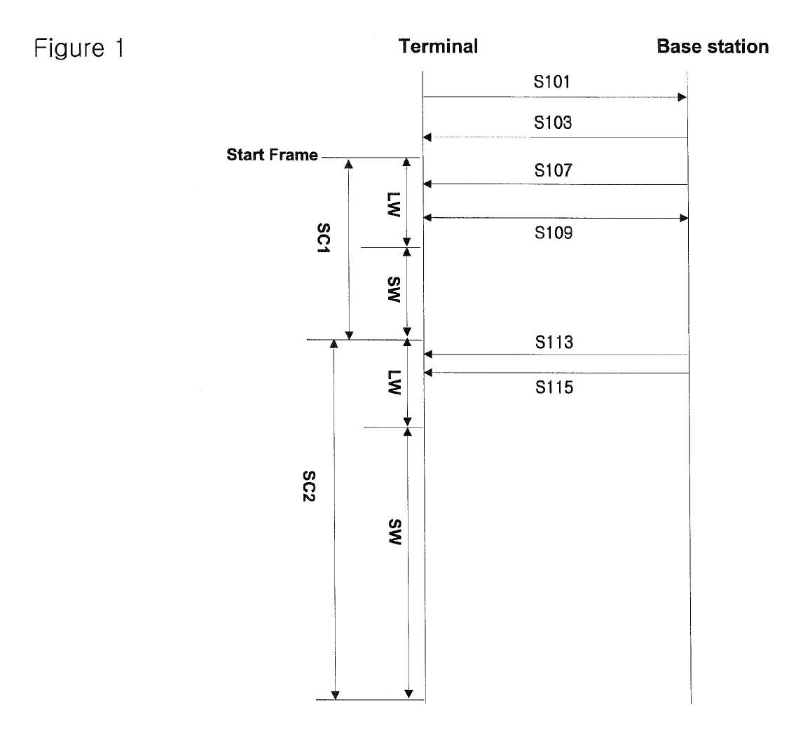

FIG. 1 is a configuration diagram sequentially illustrating a sleep mode operation according to an embodiment of the present invention.

A terminal performs a communication with a base station in a normal or active mode, and transmits a sleep-request (SLP-REQ) message for entering into a sleep mode to the base station if there exists no more traffic to be transmitted and/or received to and/or from the base station (S101).

The base station receives the SLP-REQ message from the terminal, transmits a sleep-response (SLP-RSP) message to the terminal in response to the SLP-REQ message (S103).

The SLP-RSP message may include a sleep parameter for operating the sleep mode of a terminal, such as a sleep cycle, a listening window, and the like.

According to circumstances, even without the sleep-request message of the terminal (S101), the base station may directly transmit an unsolicited SLP-RSP message to the terminal, thereby giving a command to allow the terminal to enter into a sleep mode.

The terminal that has received a SLP-RSP message from the base station changes the state to a sleep mode by referring to a sleep operating parameter to perform a sleep mode operation.

The sleep mode may include a sleep window (SW) incapable of receiving data and a listening window (LW) capable of receiving data.

In the sleep mode, the base station transmits a traffic-indication (TRF-IND) message to the terminal to indicate whether or not there exists traffic to be transferred to the terminal during a listening window (S107).

The TRF-IND message indicating the existence or non-existence of the traffic is set to positive indication if there exists traffic, but set to negative indication if there exists no traffic.

If a positive TRF-IND message is received, then the terminal transmits or receives the generated data traffic during the listening window (S109), and enters into the sleep window (SW) to perform a sleep mode operation.

In the present invention, if a TRF-IND message which is set to positive indication is received during the listening window (LW), then sleep cycle information is transferred to allow the terminal to take a different sleep cycle that will be applied according to the served traffic characteristic.

The sleep cycle information corresponds to an information indicating to extend a current sleep cycle more than the previous sleep cycle or reset the current sleep cycle to an initial sleep cycle according to the generated data traffic characteristic.

The sleep cycle information may be configured with bit information of a sleep cycle flag (SCF) field included in the TRF-IND message, and according to circumstances, may be transferred through SLP-REQ, SLP-RSP, and unsolicited SLP-RSP messages or may be also transferred through a downlink sleep control extended header.

Referring to FIG. 1, there are illustrated a case where the sleep cycle information is transferred through a TRF-IND message transmitted from the base station to the terminal (S107), and a case where the sleep cycle information is transferred through an unsolicited SLP-RSP message (S115), respectively.

The terminal checks the sleep cycle information transferred through the TRF-IND message, unsolicited SLP-RSP message, or the like and adjusts the sleep cycle (SC) according to the data traffic characteristic transmitted or received by itself, thereby performing a more effective sleep mode operation.

For example, if the base station transmits only a downlink control message or short message to the terminal, then the base station transmits positive traffic indication to the terminal, and then adds a DL sleep control extended header including a SCF value to the control message or short message to be transmitted, thereby transmitting the message to the terminal.

Hereinafter, a sleep mode operation will be described as a representative example in which the sleep cycle information is configured with bit information of a SCF field to be transferred to the terminal through the TRF-IND message.

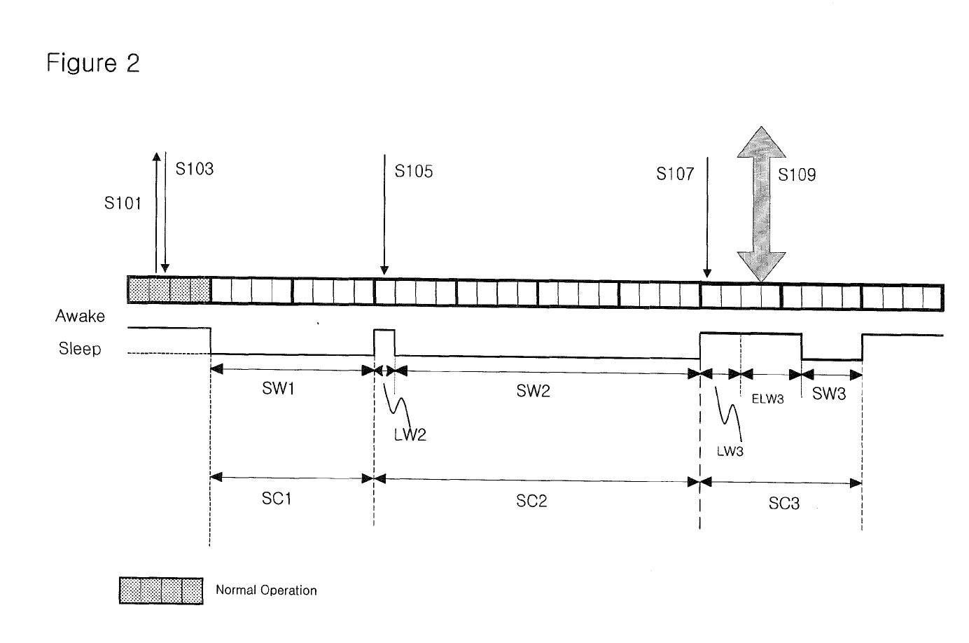

FIG. 2 is a view illustrating a typical sleep mode operation.

A terminal performs a communication with a base station in a normal state, and transmits a SLP-REQ message for entering into a sleep mode to the base station if there exists no more traffic to be transmitted or received (S101), and receives a SLP-RSP message including a sleep operating parameter such as sleep cycle, listening window, and the like from the base station (S103) to switch the state to a sleep mode.

At the time of changing the state to an initial sleep mode, the terminal applies a sleep cycle (SC1) including only the sleep window (SW1) to operate the sleep mode. From a second sleep cycle subsequent to finishing a first sleep cycle (SC1), the terminal applies the second sleep cycle (SC2) including a listening window (LW2) and a sleep window (SW2) to operate the sleep mode.

In the second sleep cycle (SC2), if a TRF-IND message including negative indication is received from the base station during the listening window (LW2) (S105), then the terminal determines that there exists no data traffic transmitted to a downlink, thereby increasing the current sleep cycle twice.

If a TRF-IND message including positive indication is received during the listening window (LW3) of the following sleep cycle (SC3) after the sleep cycle (SC2) increased twice is finished (S107), then the terminal extends a listening window (ELW3) to receive the generated data traffic and receives data traffic from the base station and enters into a sleep window (SW3) again to perform a sleep mode operation. At this time, the third sleep cycle (SC3) includes a listening window (LW3), an extended listening window (ELW3), and sleep window (SW3) to be reset to an initial sleep cycle (SC1).

Referring to FIG. 1, as described above, according to the present invention, if the terminal receives TRF-IND which is set to positive indication in the listening window (LW3) (S107), then the sleep cycle to be applied currently is not always reset to an initial sleep cycle, but the sleep cycle is adjusted to allow the terminal to take a different sleep cycle according to the served traffic characteristic.

According to an embodiment of the present invention, a sleep cycle flag (SCF) field for adjusting the sleep cycle is added to a TRF-IND message transmitted from the base station to the terminal, thereby allowing the base station to indicate the sleep cycle to be applied by the terminal.

In other words, if traffic to be transmitted from the base station to the terminal is generated, then a TRF-IND message including positive indication is transmitted in the listening window, and at this time a SCF field is included and transmitted to the terminal to operate the sleep cycle to be applied according to the traffic characteristic served by the terminal in a different way.

The SCF field of a TRF-IND message according to an embodiment of the present invention will be described with reference to the following Table 1.

TABLE 1

| Syntax | Size (bit) | Notes |
|---|---|---|
| TRF-IND{ | | |
| ... | | |
| SCF | 1 | 0: Reset to Initial Sleep Cycle |
| | | 1: min |
| | | (2x previous sleep cycle, Final Sleep Cycle) |
| ... | | |
| } | | |

If the SCF field is set to “0” in the TRF-IND (positive indication setting), then the terminal applies an initial sleep cycle to the current sleep cycle to operate the sleep mode.

However, if the SCF field is set to “1” in the TRF-IND (positive indication setting), then the terminal increases the current sleep cycle to twice the previous sleep cycle to operate the sleep mode.

The case where the SCF field is set to “1” may be a case where only non-periodic messages such as a short message or control message are transmitted during a listening window.

If the sleep mode operation is reset to an initial sleep cycle even in a case of receiving non-real time services having a non-periodic characteristic, similarly to a case of receiving real time services, then the effect of operating a sleep mode for power reduction in a terminal will be decreased.

Accordingly, in case where the characteristic of packet bursts received by the terminal is periodic, the base station sets the SCF bit to “0” to transfer TRF-IND (positive indication) to the terminal. Then, the terminal sets the sleep cycle to an initial sleep cycle which is a value negotiated through SLP-REQ/RSP at the time of initializing the sleep mode, thereby applying the sleep cycle to the sleep mode. In addition, in case where the characteristic of packet bursts is non-periodic, the base station sets the SCF bit to “1” to transfer TRF-IND (positive indication) to the terminal, and the terminal applies a min (2*previous sleep cycle, final sleep cycle) value to the sleep cycle, thereby operating the sleep mode.

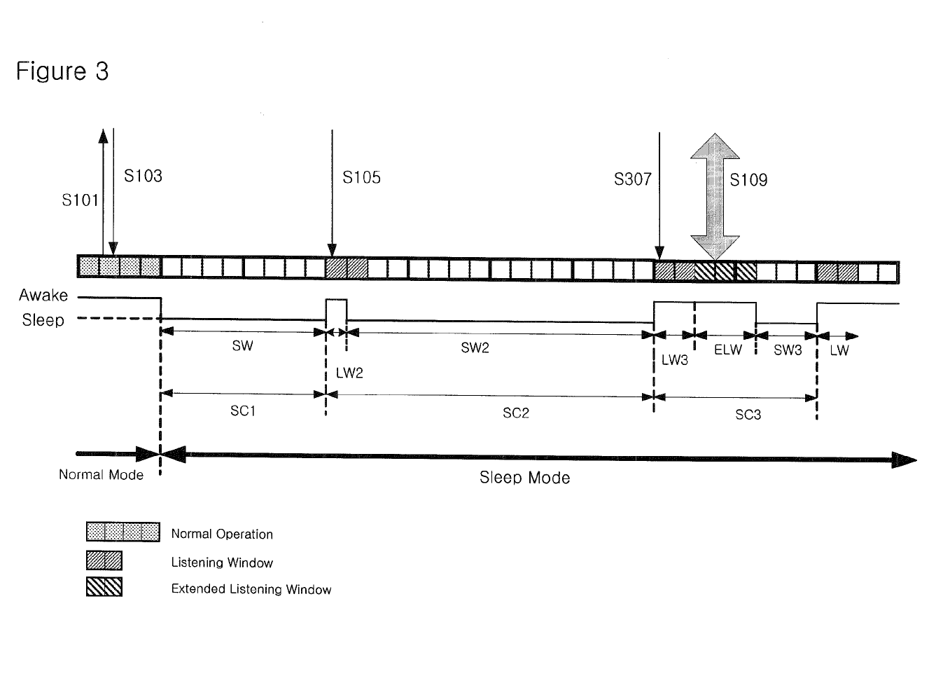

FIG. 3 is a view illustrating that the sleep cycle is reset to an initial sleep cycle in case where SCF is set to “0” and transferred to a terminal. As illustrated in the drawing, the terminal receives negative indication from the base station during a listening window (LW2) of the second sleep cycle (SC2) (S105), and determines that there exists no data traffic received by a downlink, thereby increasing the current sleep cycle (SC2) to twice the previous sleep cycle (SC1).

Subsequently, if positive indication is received during a listening window (LW3) of the following third sleep cycle (SC3) from the base station (S107), then it is checked that the SCF value field, which is sleep cycle information transferred from the base station, is set to “0”, and resets the sleep cycle (SC3) to an initial sleep cycle (SC1) as in the following equation.

Current sleep cycle(SC3)=initial sleep cycle(SC1) [Equation 1]

At this time, traffic transferred from the base station is received during an extended listening window (ELW) (S109), and the traffic may be real time data traffic having a periodic characteristic.

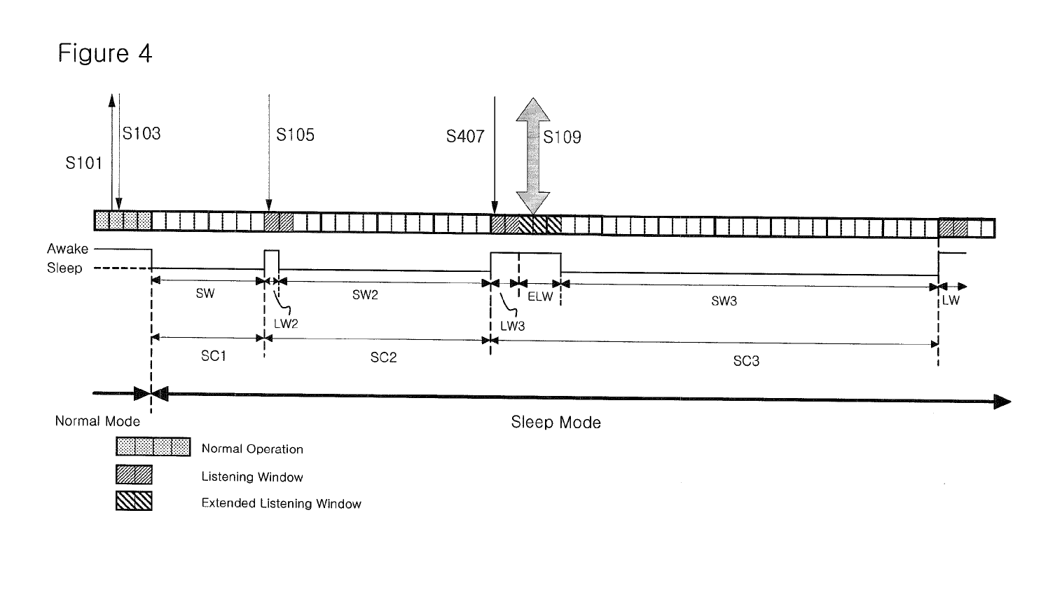

FIG. 4 is a view illustrating that the sleep cycle is increased to twice the previous sleep cycle in case where SCF is set to “1” and transferred to a terminal.

As illustrated above, the terminal receives negative indication from the base station during a listening window (LW2) of the second sleep cycle (SC2) (S105), and determines that there exists no data traffic received by a downlink, thereby increasing the current sleep cycle (SC2) to twice the previous sleep cycle (SC1).

Subsequently, if positive indication is received during a listening window (LW3) of the following third sleep cycle (SC3) from the base station (S107), then it is checked that the SCF value field, which is sleep cycle information transferred from the base station, is set to “1”, and resets the sleep cycle (SC3) to twice the previous sleep cycle (SC2) as in the following equation.

Current sleep cycle(SC3)=min(2*previous sleep cycle(SC2), final sleep cycle) [Equation 2]

At this time, traffic transferred from the base station is received during an extended listening window (ELW) (S109), and the traffic may be non-real time data traffic having a non-periodic characteristic.

Furthermore, according to another embodiment of the present invention, a SCF field transferred through a TRF-IND message may be represented with 2-bits information as illustrated in the following Table 2.

TABLE 2

| Syntax | Size (bit) | Notes |
|---|---|---|
| SCF | 2 | 0b00: current sleep cycle = initial sleep cycle |
| | | 0b01: current sleep cycle = min (2 * previous sleep |
| | | cycle, final sleep cycle) |
| | | 0b10: current sleep cycle = new initial sleep cycle |
| | | 0b11: reserved |

Referring to Table 2, it indicates that the current sleep cycle is reset to an initial sleep cycle if bit information of the SCF field is “0b00”, and indicates that the current sleep cycle is extended to twice the previous sleep cycle if bit information of the SCF field is “0b01”. In addition, it indicates that the current sleep cycle is newly reset to a new initialized sleep cycle if bit information of the SCF field is “0b10”.

As a result, in case where only short messages are transmitted to the terminal or only control messages should be transmitted during a listening window, the base station transmits positive traffic indication to the terminal, and then SCF is set to “0b10” through a TRF-IND message or unsolicited SLP-RSP message, and thus a value increased to twice the previous sleep cycle may be applied to the current sleep cycle length.

The SCF may be transferred through SLP-REQ, SLP-RSP, unsolicited SLP-RSP or a DL sleep control extended header as well as through a TRF-IND message.

An embodiment is illustrated in the following Table 3 in which a SCF value is transferred through a DL sleep control extended header. In case where only a DL control message or short message is transmitted to the terminal, the base station transmits positive traffic indication to the terminal, and then adds a DL sleep control extended header including a SCF value to the control message or short message to be transmitted, thereby transmitting the message to the terminal.

TABLE 3

| Syntax | Size (bit) | Notes |
|---|---|---|
| Last | 1 | Last Extended Header indication: |
| | | 0 = one or more extended header follows the current extended |
| | | header unless specified otherwise; |
| | | 1 = this extended header is the last extended header unless |
| | | specified otherwise |
| Type | — | Type of Extended header |
| Sleep_Cycle_ID (SCID) | 4 | — |
| Operation | 2 | 0b00: Exit Sleep Mode |
| | | 0b01: Change Sleep Mode |
| | | 0b10: Extension of Listening Widow |
| | | 0b11: Termination of Listening Window |
| if(Operation == 0b10) | — | — |
| { | | |
| Extendable Listening | 4 | Measured in Frames |
| Window | | |
| } | | |
| else if (operation == 0b01) | | |
| { | | |
| SCF | 2 | 0b00: Current sleep cycle = Initial Sleep Cycle |
| | | 0b01: Current sleep cycle = min (2 * previous sleep cycle, final |
| | | sleep cycle) |
| | | 0b10: Current sleep cycle = New Initial Sleep Cycle |
| | | 0b11: reserved |
| if (SCF ==0b10) { | | |
| New initial sleep window | 8 | The number of bits is same as the initial sleep window value |
| } | | |
| } | | |
| Reserved | variable | Reserved bits are added at the end of DL Sleep Control Extended |
| | | Header for byte alignment |

An embodiment according to the present invention is illustrated in the following Table 4 in which a SCF value is transferred through SLP-REQ.

TABLE 4

| Syntax | Size (bit) | Notes |
|---|---|---|
| AAI_SLP-REQ ( ) { | | |
| Request_Code | 2 | 0b00: Exit from Sleep Mode |
| | | 0b01: Enter Sleep Mode |
| | | 0b10: Change Sleep Mode |
| | | 0b11: Reserved |
| Sleep_Cycle_ID (SCID) | 4 | |
| if(Request_Code == 0b01) { | — | — |
| Traffic Indication Message Flag | 1 | If TIMF = 0, then a Traffic Indication Message is never |
| (TIMF) | | sent |
| | | If TIMF = 1, then a Traffic Indication Message is sent |
| | | every Listening window |
| Listening window Extension Flag | 1 | If LWEF = 0, the Listening window is of fixed duration. |
| (LWEF) | | If LWEF = 1, the Listening window can be extended and |
| | | is of variable duration |
| | | In case of TIMF = 1, LWEF shall be set to 1 |
| SCF | 2 | 0b00: Current sleep cycle = Initial Sleep Cycle |
| | | 0b01: Current sleep cycle = min (2 * previous sleep |
| | | cycle, final sleep cycle) |
| | | 0b10: Current sleep cycle = New Initial Sleep Cycle |
| | | 0b11: reserved |
| if (SCF ==0b10) { | | |
| New initial sleep window | 8 | The number of bits is same as the initial sleep window |
| | | value |
| } | | |
| Early Listening Window | 1 | If ELWTF = 0, the early listening window termination is |
| Termination Flag (ELWTF) | | not supported. |
| | | If ELWTF = 1, the early listening window termination is |
| | | supported. |
| Start Frame Number | 6 | Start frame number for first sleep window |
| Initial Sleep Cycle | 8 | — |
| Final Sleep Cycle | 10 | — |
| Listening Window | 6 | — |
| if(LWEF == 1) { | | |
| T_AMS | 4 | Measured in Frames |
| T_HARQ_Retx | 4 | Measured in Frames |
| } | | |
| } | | |
| else if(Request_Code == 0b10) { | | |
| SCF | 2 | 0b00: Current sleep cycle = Initial Sleep Cycle |
| | | 0b01: Current sleep cycle = min (2 * previous sleep |
| | | cycle, final sleep cycle) |
| | | 0b10: Current sleep cycle = New Initial Sleep Cycle |
| | | 0b11: reserved |
| if (SCF ==0b10) { | | |
| New initial sleep window | 8 | The number of bits is same as the initial sleep window |
| | | value |
| } | | |
| } | | |
| Padding | variable | Padding bits to ensure byte aligned. |
| } | | |

The SCF may be included in the SLP-REQ message transmitted to a base station in order to thereby enter into a sleep mode or change the sleep mode.

An embodiment according to the present invention is illustrated in the following Table 5 in which a SCF value is transferred through SLP-RSP.

TABLE 5

| Syntax | Size (bit) | Notes |
|---|---|---|
| AAI_SLP-RSP ( ) { | | |
| Response_Code | 2 | 0b00: Request by ABS in Unsolicited Manner |
| | | 0b01: Approval of AAI_SLP-REQ |
| | | 0b10: Rejection of AAI_SLP-REQ |
| | | 0b11: Reserved |
| if(Response_Code == 0b00 \|\| 0b01) | | |
| { | | |
| Operation | 2 | 0b00: Exit Sleep Mode |
| | | 0b01: Enter Sleep Mode |
| | | 0b10: Change Sleep Mode |
| | | 0b11: Reserved |
| Sleep_Cycle_ID (SCID) | 4 | |
| if(Operation == 0b01 { | — | — |
| Traffic Indication Message Flag | 1 | If TIMF = 0, then a Traffic Indication Message is never |
| (TIMF) | | sent |
| | | If TIMF = 1, then a Traffic Indication Message is sent |
| | | every Listening window |
| Listening window Extension Flag | 1 | If LWEF = 0, the Listening window is of fixed duration. |
| (LWEF) | | If LWEF = 1, the Listening window can be extended and |
| | | is of variable duration |
| | | In case of TIMF = 1, LWEF shall be set to 1 |
| Early Listening Window | 1 | If ELWTF = 0, the early listening window termination is |
| Termination Flag (ELWTF) | | not supported. |
| | | If ELWTF = 1, the early listening window termination is |
| | | supported. |
| Start Frame Number | 6 | Start frame number for first sleep window |
| Initial Sleep Cycle | 8 | — |
| Final Sleep Cycle | 10 | — |
| Listening Window | 6 | — |
| if(TIMF == 1) { | | |
| SLPID | 10 | — |
| Reserved | 2 | |
| } | | |
| if(LWEF == 1) { | | |
| T_AMS | 4 | Measured in Frames |
| T_HARQ_Retx | 4 | Measured in Frames |
| } | | |
| if(Operation == 0b10 { | | |
| SCF | 2 | 0b00: Current sleep cycle = Initial Sleep Cycle |
| | | 0b01: Current sleep cycle = min (2 * previous sleep |
| | | cycle, final sleep cycle) |
| | | 0b10: Current sleep cycle = New Initial Sleep Cycle |
| | | 0b11: reserved |
| if (SCF ==0b10) { | | |
| New initial sleep window | 8 | The number of bits is same as the initial sleep window |
| | | value |
| } | | |
| } | | |
| Padding | variable | Padding bits to ensure byte aligned. |
| } | | |
| else if(Response_Code == 0b10) { | — | |
| REQ_duration | | |
| Reserved | | |
| } | — | |
| } | | |

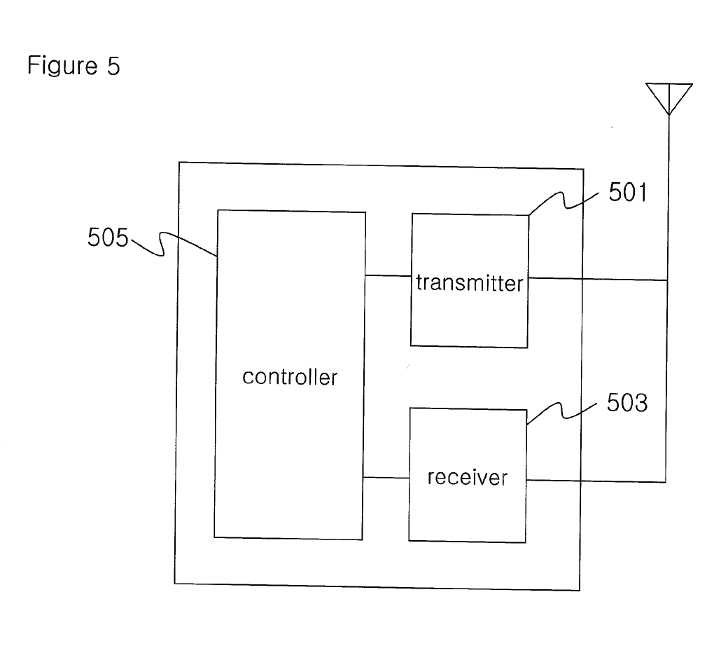

FIG. 5 is a block diagram schematically illustrating a sleep mode operation apparatus according to an embodiment of the present invention.

As illustrated in the drawing, the sleep mode operation apparatus may include a transmitter 501 configured to transmit a sleep request message for entering into the sleep mode to a base station, a receiver 503 configured to receive a sleep response message and a data traffic generation indicating message including a sleep operating parameter from the base station, and a controller 505 configured to refer to the sleep operating parameter to change the state to the sleep mode.

The controller 505 refers to sleep cycle information transferred from the base station to extend the sleep cycle more than the previous sleep cycle or reset to an initial sleep cycle, thereby adjusting the sleep cycle.

The sleep cycle information transferred from the base station may be transferred through a sleep-request message (SLP-REQ), a sleep-response message (SLP-RSP), a data traffic generation indicating message (TRF-IND), an unsolicited sleep-response message (SLP-RSP), or downlink (DL) sleep control extended header.

The base station indicates to reset the sleep cycle to an initial sleep mode if the generated data traffic is a real time service, and indicates to extend the sleep cycle to twice the previous sleep cycle if the generated data traffic is a non-real time service, and the controller 505 adjusts the sleep cycle by referring to the sleep cycle information to perform a sleep mode operation.

The method according to the present invention as described above may be implemented by software, hardware, or a combination of both. For example, the method according to the present invention may be stored in a storage medium (for example, internal memory, flash memory, hard disk, and so on), and may be implemented through codes or instructions in a software program that can be performed by a processor (for example, internal microprocessor).

Though preferred embodiments of present invention are exemplarily described as disclosed above, the scope of the invention is not limited to those specific embodiments, and thus various modifications, variations, and improvements can be made in the present invention without departing from the spirit of the invention, and within the scope of the appended claims.

What is claimed is:

1. A sleep mode operation method in a mobile communication terminal, the method comprising:
transmitting a sleep mode request message including a sleep cycle information for entering into the sleep mode to a base station;
receiving a sleep mode response message including a sleep mode operating parameter from the base station;
changing the state to the sleep mode referring to the sleep mode operating parameter;
receiving a traffic indication message including a positive traffic indicator from the base station; and
adjusting to a current sleep cycle according to the sleep cycle information included in the sleep mode request message,
wherein the sleep cycle information is an information indicating to extend a current sleep cycle to the small value of twice the previous sleep cycle and a final sleep cycle or to reset the current sleep cycle to an initial sleep cycle or a new initialized sleep cycle.

2. The method of claim 1, wherein the sleep cycle information is represented in 2 bits.

3. A sleep mode operation method in a mobile communication terminal, the method comprising:
receiving a sleep mode response message including a sleep cycle information from the base station;
changing the state to the sleep mode referring to the sleep mode operating parameter within the sleep mode response message;
receiving a traffic indication message including a positive traffic indicator from the base station; and
adjusting to a current sleep cycle according to the sleep cycle information included in the sleep mode response message,
wherein the sleep cycle information is an information indicating to extend a current sleep cycle to the small value of twice the previous sleep cycle and a final sleep cycle or to reset the current sleep cycle to an initial sleep cycle or a new initialized sleep cycle.

4. The method of claim 3, wherein the sleep mode response message is a sleep mode response message corresponding to a sleep mode request message or an unsolicited sleep mode response message.

5. The method of claim 3, wherein the sleep cycle information is represented in 2 bits.

6. A sleep mode operation method in a mobile communication terminal, the method comprising:
receiving a traffic indication message including a positive traffic indicator from the base station;
receiving a control information message including a sleep cycle information during a listening window of the sleep mode from the base station; and
adjusting to a current sleep cycle considering the sleep cycle information included in the control information message,
wherein the sleep cycle information is an information indicating to extend a current sleep cycle to the small value of twice the previous sleep cycle and a final sleep cycle or to reset the current sleep cycle to an initial sleep cycle or a new initialized sleep cycle.

7. The method of 6, wherein the control information message is a sleep mode response message, an unsolicited sleep mode response message or a sleep control header(SCH).

8. The method of claim 6, wherein the sleep cycle information is represented in 2 bits.

9. A sleep mode operation method in a mobile communication terminal, the method comprising:
transmitting a control information message including a sleep cycle information during a listening window of the sleep mode to a base station;
receiving a response message corresponding to the control information message;
receiving a traffic indication message including a positive traffic indicator from the base station; and
adjusting to a current sleep cycle considering the sleep cycle information included in the control information message,
wherein the sleep cycle information is an information indicating to extend a current sleep cycle to the small value of twice the previous sleep cycle and a final sleep cycle or to reset the current sleep cycle to an initial sleep cycle or a new initialized sleep cycle.

10. The method of claim 9, wherein the control information message is a sleep mode request message or a sleep control header(SCH).

11. The method of claim 9, wherein the sleep cycle information is represented in 2 bits.

12. A sleep mode operation apparatus, the apparatus comprising:
a transmitter to transmit a sleep request message to a base station;
a receiver to receive a sleep response message including a sleep operating parameter and a data traffic indication message from the base station; and
a controller to adjust a current sleep cycle considering a sleep cycle information,
wherein the sleep cycle information is an information indicating to extend a current sleep cycle to the small value of twice the previous sleep cycle and a final sleep cycle or to reset the current sleep cycle to an initial sleep cycle or a new initialized sleep cycle.

13. The apparatus of claim 12, wherein the sleep cycle information is received by being included in an unsolicited sleep response message or sleep control header(SCH).

14. The apparatus of claim 12, wherein the sleep cycle information is represented in 2 bits.
